(19) United States
(12) Patent Application Publication
(10) Pub. No.: US 2004/0213418 A1
(43) Pub. Date: Oct. 28, 2004

(54) Method for transfer of sound source signals

(76) Inventor: Wan-Tien Chen, Taipei (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 10/724,630

(22) Filed: Dec. 2, 2003

(30) Foreign Application Priority Data
Apr. 24, 2003 (TW) 092109577

(51) Int. Cl. H04B 3/00

(52) U.S. Cl. 381/77

(57) ABSTRACT

A method for transfer of sound source signals relates to installing an insulator in a socket adapter, wherein the insulator is able to drive a detective circuit for detecting whether a sound source plug is inserted in the socket adapter. When any sound source plug is inserted in the socket adapter, the rear IC device executes the process to transfer the signals from sound sources.

### BACKGROUND OF THE INVENTION

1. Field of the Invention

The present invention relates to a method for transfer of transfer of sound source signals, particularly to a method for transfer of sound source signals like line-out, line-in, mike-in, and earphone-out, In the present invention, an insulator installed in a socket adapter can drive a detective circuit to determine whether there is a sound source plug inserted in the socket adapter or not. When there is a sound source plug inserted in, the transfer processing can be executed by a rear IC device.

2. Description of the Prior Art

In a conventional method for transfer of sound source signals, as shown in FIG. 5, the signals at the output of the sound source signals are first processed by a output amplifier 1, and then are transmitted to the loudspeaker 3 through the output adapter 2 for outputting. The signals at the input of the sound source signals are first received by the microphone 4, and then are transmitted to the input amplifier 6 through input adapter 5 for processing. As shown in FIG. 6, the output adapter 2 and the input adapter 5 are respectively composed of the terminals P1-P5, wherein the terminal PI is connected to the ground, the terminals P2, P5 and the terminals P3, P4 respectively constitute an electrical circuit.

However, when the quantity of the adapter like adapters 2, 5 is increased, it is difficult for user to distinguish the type of the adapter. Once the adapter is used incorrectly, it can not operate normally. As above stated, the conventional method for transfer of sound source signals has its shortcoming, hence, an improved method for transfer of sound source signals is needed.

### SUMMARY OF THE INVENTION

The present invention is to provide a method for transfer of transfer of sound source signals which has the following advantages, effects and objectives:

01. The present invention can determine that whether there is a sound source plug inserted in the socket adapter or not;

02. The insulator in the socket adapter of the present invention constitutes an independent detective switch;

03. The rear IC device of the present invention can more easily determine the type of the sound source plug by a voltage dividing circuit;

04. The present invention can omit the circuit parts (like filter device) needed in conventional method for transfer of sound source signals.

The technical means and the specific capacity of the present invention now are described in detail by preferred embodiments and accompanying drawings as the following.

### BRIEF DESCRIPTION OF THE DRAWINGS

FIG. 1 is a schematic diagram of the executed circuit of the present invention;

FIG. 2 is a schematic diagram of the socket adapter circuit of the present invention;

FIG. 2A is an executed circuit diagram of the socket adapter of the present invention;

FIG. 2B is a diagram of the executed circuit with two socket adapters in the present invention;

FIG. 2C is a diagram of the executed circuit with three socket adapters in the present invention;

FIG. 2D is a diagram of the executed circuit with four socket adapters in the present invention;

FIG. 2E is a diagram of the executed circuit with five socket adapters in the present invention;

FIG. 3 is an executed situation diagram of FIG. 2;

FIG. 4 is an executed situation diagram of the second preferred embodiment of the present invention;

FIG. 5 is a schematic diagram of a conventional executed circuit;

FIG. 6 is a schematic diagram of a conventional socket adapter circuit.

### DETAILED DESCRIPTION OF THE PREFERRED EMBODIMENT

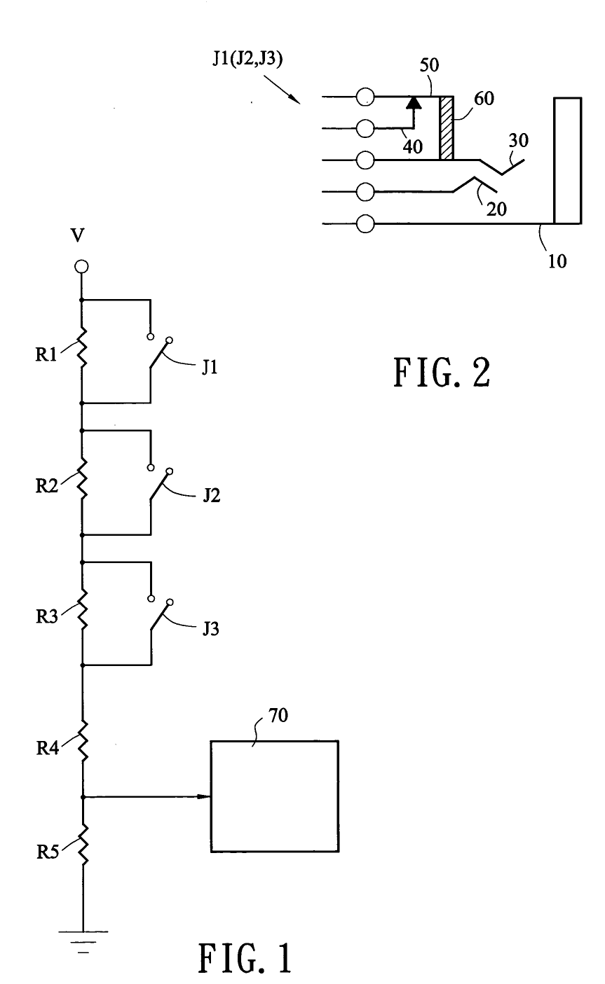

Referring to FIG. 1, in the method of a preferred embodiment in accordance with the present invention, a voltage dividing circuit composed of socket adapters J1-J3 and resistors R4-R5 in series connects a rear IC device 70 for determining whether the socket adapters J1-J3 are inserted in by sound source plugs or not. If there is any sound source plug inserted in, the transfer processing of the signals from sound source can be processed by the rear IC device 70. Each socket adapter is an independent detective switch, wherein the socket adapter J1 connects the resistor R1 in parallel, the socket adapter J2 connects the resistor R2 in parallel and the socket adapter J3 connects the resistor R3 in parallel. Whereby the sound signals can be transferred between line-in, line-out, mike-in, and earphone-out.

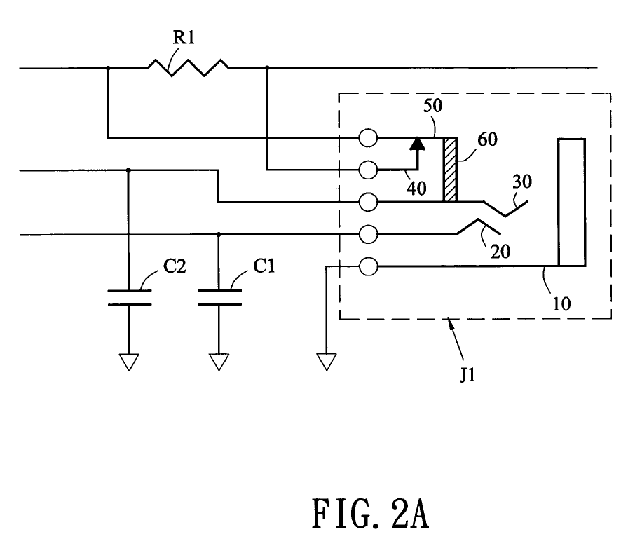

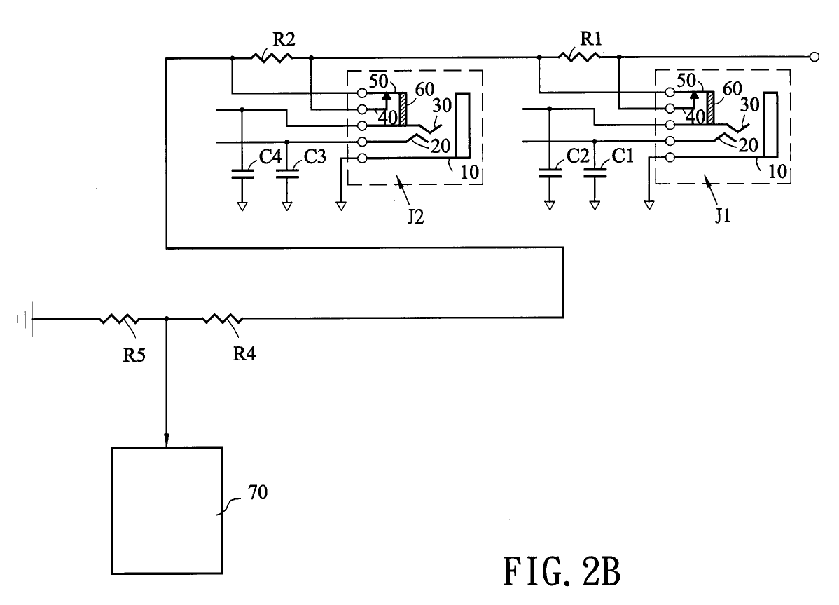

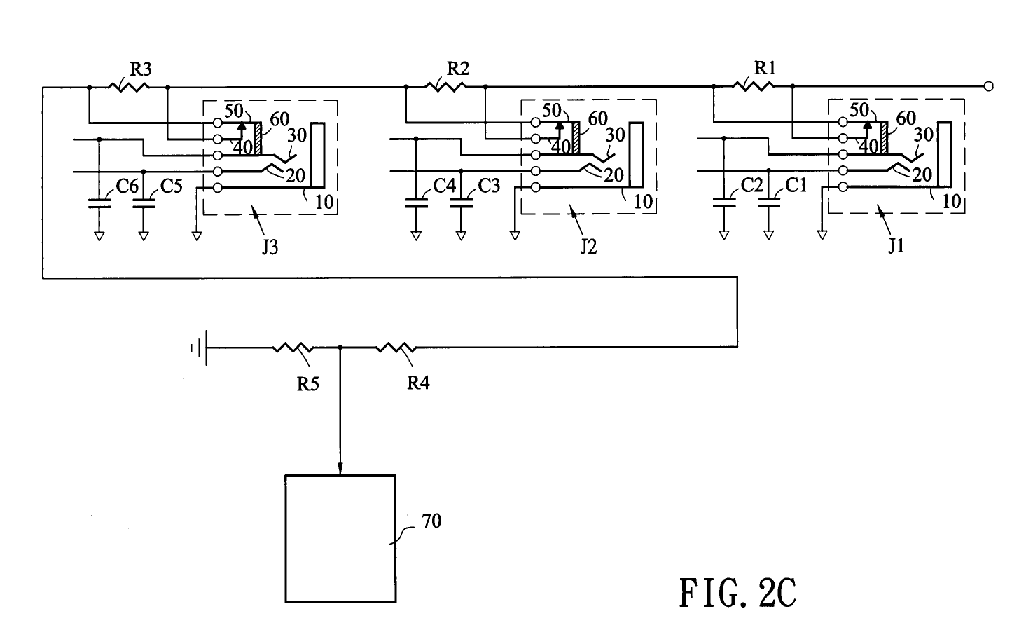

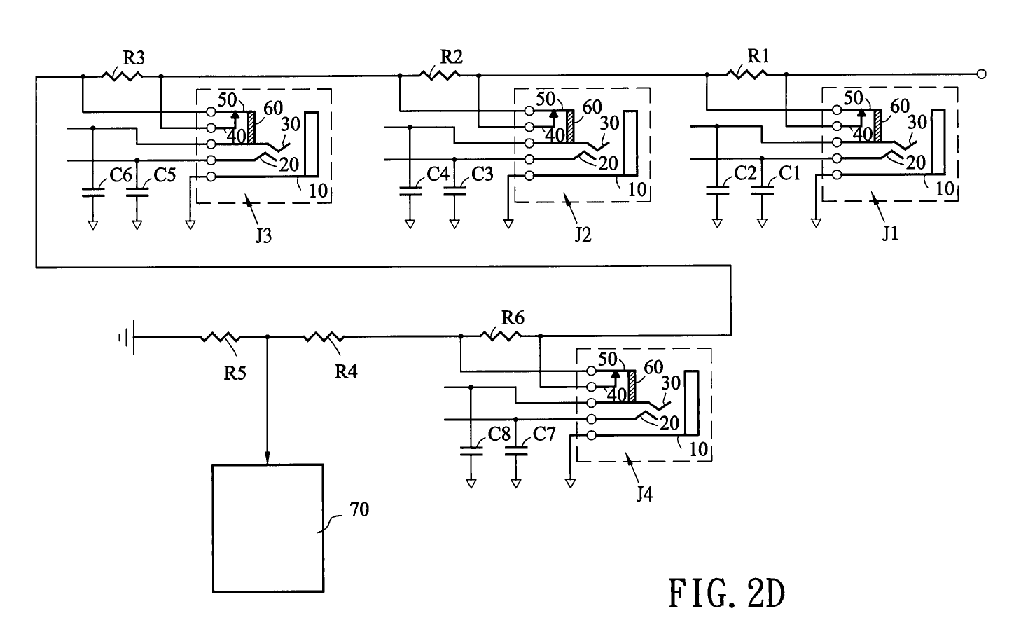

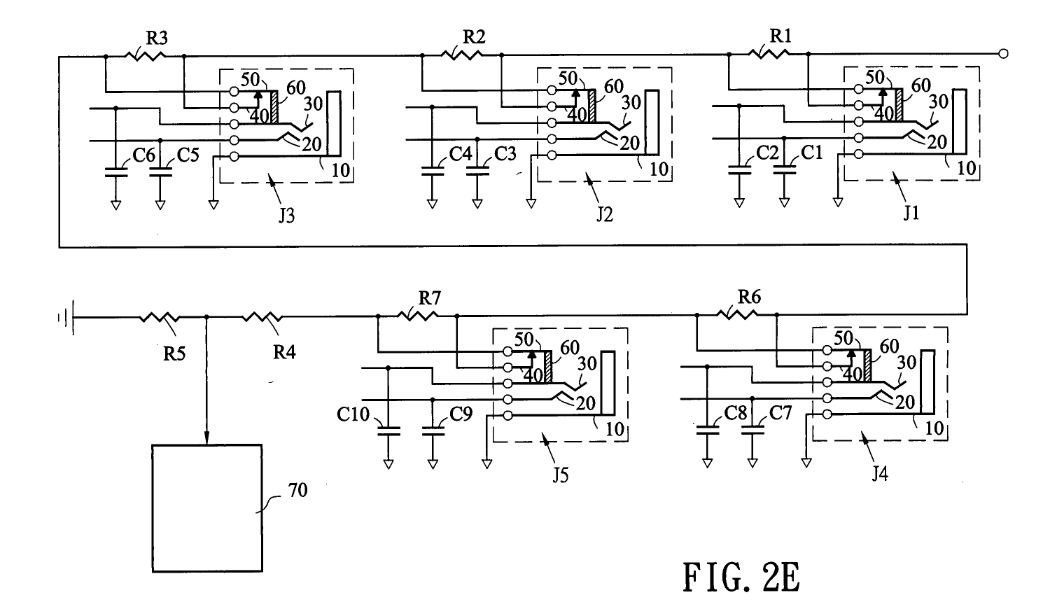

Referring to FIGS. 2 and 2A, in the preferred embodiment, said each socket adapter J1-J3 has an insulator 60 in it and is provided with a first terminal 10, a second terminal 20, a third terminal 30, a fourth terminal 40 and a fifth terminal 50, wherein said first terminal 10 is connected to the ground and when there is no sound source plug (not shown in FIGS) inserted in, said fourth terminal 40 and fifth terminal 50 keep electrical contact to form a detective circuit.

The preferred embodiment of the executed circuit of the socket adapter in accordance with the present invention can be further described by taking the socket adapter J1 as an example. As shown in FIG. 2A, the first terminal 10 is connected to the ground, the second terminal 20 connects a capacitor C1, the third terminal 30 connects another capacitor C2, and the fourth terminal 40 and the fifth terminal 50 connect the resistor R1 in parallel. The socket adapters J2-J3 are similar with this exemplary circuit. All of them are the feasible means of the present invention.

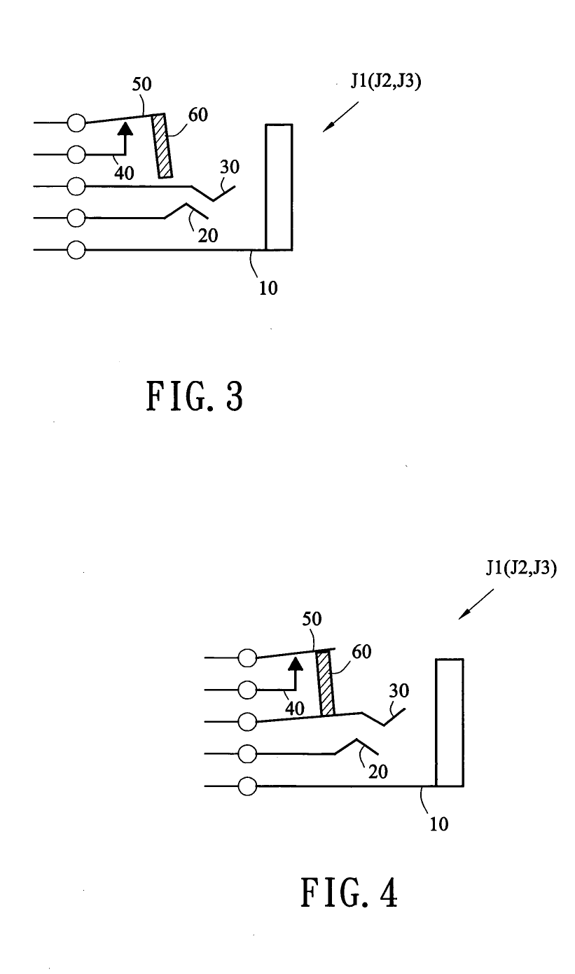

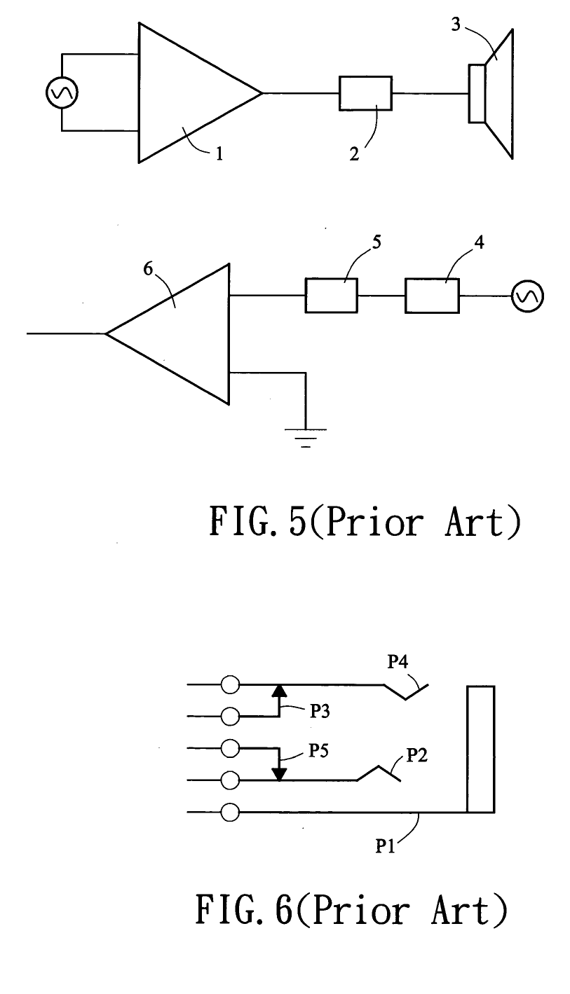

Referring to FIG. 3, in the preferred embodiment of the present invention, when a sound source plug (not shown in FIG) inserts in the socket adapters J1-J3, the sound source plug can touch the second terminal 20 and the third terminal 30 so that the insulator 60 can be driven to separate the fourth terminal 40 from the fifth terminal 50, whereby the detective circuit is in off-state. Meanwhile, the rear IC device 70 can determine that there is a sound source plug inserted in the socket adapters J 1-J3 and can further measure the resistance of the sound source plug by the voltage dividing circuit, whereby the type of the sound source plug can be determined and the transfer processing of the signals from the sound source can be executed exactly.

Referring to FIG. 4, in the second preferred embodiment of the present invention, when a sound source plug (not shown in FIG) inserts in the socket adapter J1-J3, the insulator 60 can also be driven by the third terminal 30 to separate the fourth terminal 40 from the fifth terminal 50, that is, the third terminal 30 can touch and drive the insulator 60, and the insulator 60 sequentially drives the fifth terminal 50 so that the electrical contact between the fifth terminal 50 and the fourth terminal 40 can be cut off. This is another feasible means of the present invention.

Referring to FIGS. 2A˜2E, the quantity of the socket adapter of the present invention can be from one to six for executing a single or multiple channel function. What is shown in FIG. 2B is the preferred embodiment with two socket adapters J1, J2 of the present invention. In socket adapter J1, the first terminal 10 is connected to the ground, the second terminal 20 connects a capacitor C1, the third terminal 30 connects another capacitor C2, and the fourth terminal 40 and the fifth terminal 50 connect resistor R1 in parallel. In socket adapter J2, the first terminal 10 is connected to the ground, the second terminal 20 connects a capacitor C3, the third terminal 30 connects another capacitor C4, and the fourth terminal 40 and the fifth terminal 50 connect the resistor R2 in parallel.

What is shown in FIG. 2C is the preferred embodiment with three socket adapters J1, J2, J3 of the present invention. The circuits of the socket adapters J1, J2 in FIG. 2C are the same as in FIG. 2B. As for the socket adapter J3, the first terminal 10 is connected to the ground, the second terminal 20 connects a capacitor C5, the third terminal 30 connects another capacitor C6, the fourth terminal 40 and the fifth terminal 50 connect a resistor R3 in parallel.

What is shown in FIG. 2D is the preferred embodiment with four socket adapters J1, J2, J3, J4 of the present invention. The circuits of the socket adapters J1, J2, J3 in FIG. 2D are the same as in FIG. 2C. As for the socket adapter J4, the first terminal 10 is connected to the ground, the second terminal 20 connects a capacitor C7, the third terminal 30 connects another capacitor C8, the fourth terminal 40 and the fifth terminal 50 connect a resistor R6 in parallel.

What is shown in FIG. 2E is the preferred embodiment with five socket adapters J1, J2, J3, J4, J5 of the present invention. The circuits of the socket adapters J1, J2, J3, and J4 in FIG. 2E are the same as in FIG. 2D. As for the socket adapter J5, the first terminal 10 is connected to the ground, the second terminal 20 connects a capacitor C9, the third terminal 30 connects another capacitor 10, and the fourth terminal 40 and the fifth terminal 50 connect a resistor R7 in parallel. A preferred embodiment with six socket adapters in accordance with the present invention can be deduced from the FIGS. 2B˜2E.

The above mentioned are parts of feasible means of the present invention. All of them are the preferred embodiments of the present invention and are in accordance with the spirit of the present invention. Therefore, they should be included in the claims of the present invention.

What is claimed is:

1. A method for transfer of sound source signals comprising a voltage dividing circuit composed of three socket adapters J1-J3 and two resistors R4-R5 in series and connected with a rear IC device;
each of the socket adapters J1-J3 having an insulator therein and being provided with a first terminal, a second terminal, a third terminal, a fourth terminal and a fifth terminal, wherein said first terminal is connected to the ground, and when there is no sound source plug in, said fourth terminal and fifth terminal keep electrically contact to form a detective circuit;
said socket adapter J1 connecting a resistor R1 in parallel, said socket adapter J2 connecting a resistor R2 in parallel and said socket adapter J3 connecting a resistor R3 in parallel;
when a sound source plug being inserted in the socket adapters J1-J3, the sound source plug being able to electrically contact the second terminal and the third terminal and to drive the insulator to separate the fourth terminal from the fifth terminal so that the detective circuit being in off-state;
whereby the rear IC device being able to determine that there is a sound source plug inserted in the socket adapters J1-J3 and further measure the resistance of the sound source plug by the voltage dividing circuit so that the type of the sound source plug being able to be determined and the transfer processing of the signals from the sound source being able to be executed exactly.

2. The method for transfer of sound source signals as claimed in claim 1, wherein when a sound source plug inserts in the socket adapters J1-J3, the insulator also can be driven by the third terminal to separate the fourth terminal from the fifth terminal.

3. A method for transfer of sound source signals comprising a voltage dividing circuit composed of a single socket adapter J1 and two resistors R4-R5 in series and connected with a rear IC device;
said socket adapter J1 having an insulator therein and being provided with a first terminal, a second terminal, a third terminal, a fourth terminal and a fifth terminal, wherein said first terminal is connected to the ground, and when there is no sound source plugged in, said fourth terminal and fifth terminal keep electrically contact to form a detective circuit and connect a resistor R1 in parallel outside the said socket adapter J1;
when a sound source plug being inserted in the socket adapter J1, the sound source plug being able to electrically contact the second terminal and the third terminal to drive the insulator to separate the fourth terminal from the fifth terminal so that the detective circuit being in off-state;
whereby the rear IC device being able to determine that there is a sound source plug inserted in the socket adapter J1 and further measure the resistance of the sound source plug by the voltage dividing circuit so that the type of the sound source plug being able to be determined and the transfer processing of the signals from the sound source being able to be executed exactly.

4. The method for transfer of sound source signals as claimed in claim 3, wherein when a sound source plug inserts in the socket adapter J1, the insulator also can be driven by the third terminal to separate the fourth terminal from the fifth terminal.

5. The method for transfer of sound source signals as claimed in claim 3, wherein said voltage dividing circuit can be composed of two socket adapters J1-J2 and two resistors R4-R5 in series, and each socket adapter connects a resistor in parallel.

6. The method for transfer of sound source signals as claimed in claim 3, wherein said voltage dividing circuit can be composed of four socket adapters and two resistors R4-R5 in series, moreover, each socket adapter connects a resistor in parallel.

7. The method for transfer of sound source signals as claimed in claim 3, wherein said voltage dividing circuit can be composed of five socket adapters and two resistors R4-R5 in series, and each socket adapter connects a resistor in parallel.

8. The method for transfer of sound source signals as claimed in claim 3, wherein said voltage dividing circuit can be composed of six socket adapters and two resistors R4-R5 in series, and each socket adapter connects a resistor in parallel.

9. A method for transfer of sound source signals, comprising a voltage dividing circuit composed of a socket adapter and two resistors in series and connected with a rear IC device;
said socket adapter having an insulator therein and being provided with a first terminal, a second terminal, a third terminal, a fourth terminal and a fifth terminal, wherein said first terminal is connected to the ground, said second terminal connects a capacitor C1, said third terminal connects another capacitor, said fourth terminal and fifth terminal connect a resistor R1 in parallel;
when there being no sound source plugged in, the fourth terminal and the fifth terminal keeping electrical contact to form a detective circuit, and when a sound source plug being inserted in the socket adapter, the sound source plug being able to electrically contact the second terminal and the third terminal to drive the insulator to separate the fourth terminal from the fifth terminal so that the detective circuit being in off-state;
whereby the rear IC device being able to determine that there is a sound source plug inserted in the socket adapter and further to measure the resistance of the sound source plug by the voltage dividing circuit so that the type of the sound source plug being able to be determined and the transfer processing of the signals from the sound source being able to be executed exactly.

10. The method for transfer of sound source signals as claimed in claim 9, wherein when a sound source plug inserts in the socket adapter, the insulator also can be driven by the third terminal to separate the fourth terminal from the fifth terminal.

11. The method for transfer of sound source signals as claimed in claim 9, wherein said voltage dividing circuit can be composed of two socket adapters J1-J2 and two resistors R4-R5 in series;
said socket adapter J1 having an insulator therein and being provided with a first terminal, a second terminal, a third terminal, a fourth terminal and a fifth terminal, wherein said first terminal is connected to the ground, said second terminal connects a capacitor C1, said third terminal connects another capacitor C2, said fourth terminal and said fifth terminal connect a resistor R1 in parallel;
said socket adapter J2 having an insulator therein and being provided with a first terminal, a second terminal, a third terminal, a fourth terminal and a fifth terminal, wherein said first terminal is connected to the ground, said second terminal connects a capacitor C3, said third terminal connects another capacitor C4, said fourth terminal and said fifth terminal connect a resistor R2 in parallel.

12. The method for transfer of sound source signals as claimed in claim 9, wherein said voltage dividing circuit can be composed of three socket adapters J1-J3 and two resistors R4-R5 in series;
said socket adapter J1 having an insulator therein and being provided with a first terminal, a second terminal, a third terminal, a fourth terminal and a fifth terminal, wherein said first terminal is connected to the ground, said second terminal connects a capacitor C1, said third terminal connects another capacitor C2, said fourth terminal and said fifth terminal connect a resistor R1 in parallel;
said socket adapter J2 having an insulator therein and being provided with a first terminal, a second terminal, a third terminal, a fourth terminal and a fifth terminal, wherein said first terminal is connected to the ground, said second terminal connects a capacitor C3, said third terminal connects another capacitor C4, said fourth terminal and said fifth terminal connect a resistor R2 in parallel;
said socket adapter J3 having an insulator therein and being provided with a first terminal, a second terminal, a third terminal, a fourth terminal and a fifth terminal, wherein said first terminal is connected to the ground, said second terminal connects a capacitor C5, said third terminal connects another capacitor C6, said fourth terminal and said fifth terminal connect a resister R3 in parallel.

13. The method for transfer of sound source signals as claimed in claim 9, wherein said voltage dividing circuit can be composed of four socket adapters J1, J2, J3, and J4 and two resistors R4, R5 in series;
said socket adapter J1 having an insulator therein and being provided with a first terminal, a second terminal, a third terminal, a fourth terminal and a fifth terminal, wherein said first terminal is connected to the ground, said second terminal connects a capacitor C1, said third terminal connects another capacitor C2, said fourth terminal and said fifth terminal connect a resistor R1 in parallel;
said socket adapter J2 having an insulator therein and being provided with a first terminal, a second terminal, a third terminal, a fourth terminal and fifth terminal, wherein said first terminal is connected to the ground, said second terminal connects a capacitor C3, said third terminal connects another capacitor C4, said fourth terminal and said fifth terminal connect a resistor R3 in parallel;
said socket adapter J3 having an insulator therein and being provided with a first terminal, a second terminal, a third terminal, a fourth terminal and a fifth terminal, wherein said first terminal is connected to the ground, said second terminal connects a capacitor C5, said third terminal connects another capacitor C6, said fourth terminal and said fifth terminal connect a resistor R3 in parallel;
said socket adapter J4 having an insulator therein and being provided with a first terminal, a second terminal, a third terminal, a fourth terminal and a fifth terminal, wherein said first terminal is connected to the ground, said second terminal connects a capacitor, said third terminal connects another capacitor C8, said fourth terminal and said fifth terminal connect a resistor R6 in parallel.

14. The method for transfer of sound source signals as claimed in claim 9, wherein said voltage dividing circuit can be composed of five socket adapters J1-J5 and two resistors R4-R5 in series;
said socket adapter J1 having an insulator therein and being provided with a first terminal, a second terminal, a third terminal, a fourth terminal and a fifth terminal, wherein said first terminal is connected to the ground, said second terminal connects a capacitor C1, said third terminal connects another capacitor C2, said fourth terminal and said fifth terminal connect a resistor R1 in parallel;
said socket adapter J2 having an insulator therein and being provided with a first terminal, a second terminal, a third terminal, a fourth terminal and a fifth terminal, wherein said first terminal is connected to the ground, said second terminal connects a capacitor C3, said third terminal connects another capacitor C4, said fourth terminal and said fifth terminal connect a resistor R2 in parallel;
said socket adapter J3 having an insulator therein and being provided with a first terminal, a second terminal, a third terminal, a fourth terminal and a fifth terminal, wherein said first terminal is connected to the ground, said second terminal connects a capacitor C5, said third terminal connects another capacitor C6, said fourth terminal and said fifth terminal connect a resistor R3 in parallel;
said socket adapter J4 having an insulator therein and being provided with a first terminal, a second terminal, a third terminal, a fourth terminal and a fifth terminal, wherein said first terminal is connected to the ground, said second terminal connects a capacitor C7, said third terminal connects another capacitor C8, said fourth terminal and said fifth terminal connect a resistor R6 in parallel;
said socket adapter J5 having an insulator therein and being provided with a first terminal, a second terminal, a third terminal, a fourth terminal and a fifth terminal, wherein said first terminal is connected to the ground, said second terminal connects a capacitor C9, said third terminal connects another capacitor C10, said fourth terminal and said fifth terminal connect a resistor R7 in parallel.

15. The method for transfer of sound source signals as claimed in claim 14, wherein said voltage dividing circuit further connects a sixth socket adapter in series;
said sixth socket adapter having an insulator therein and being provided with a first terminal, a second terminal, a third terminal, a fourth terminal and a fifth terminal, wherein said first terminal is connected to the ground, said second terminal connects a capacitor, said third terminal connects another capacitor, said fourth terminal and said fifth terminal connect a resistor in parallel.
